(19) United States
(12) Patent Application Publication
(10) Pub. No.: US 2016/0099910 A1
(43) Pub. Date: Apr. 7, 2016

(54) DOCSIS/MOCA ENABLED COAX DISTRIBUTION SYSTEM

(71) Applicant: CHARTER COMMUNICATIONS OPERATING, LLC, ST. LOUIS, MO (US)

(72) Inventor: KYLE W. DREAS, AURORA, CO (US)

(73) Assignee: CHARTER COMMUNICATIONS OPERATING, LLC, ST. LOUIS, MO (US)

(21) Appl. No.: 14/503,601

(22) Filed: Oct. 1, 2014

(51) Int. Cl. H04L 29/12; H04W 24/00; H04L 12/24

(52) U.S. Cl. CPC H04L 61/157; H04L 41/0806; H04L 41/0893; H04W 24/00

(57) ABSTRACT

System, method and apparatus implementing a smart splitter for use within a DOCSIS/MoCA enabled coaxial distribution system, the splitter for coupling radiofrequency (RF) signal between an input connection and a plurality of output connections, wherein each output connection is associated with a respective outlet, the splitter including a management module, configured to receive identifying data associated with at least one outlet or customer device connected thereto.

### FIELD OF THE INVENTION

The invention relates to managing commercial or residential premises equipment and more particularly but not exclusively, to managing radiofrequency (RF) signal splitter connections to outlets and devices connected thereto within commercial or residential premises.

### BACKGROUND

Within the context of information distribution systems such as cable television systems, residential cable splitters are typically used to provide multiple coaxial feeds to internal jacks or outlets from a signal input or “drop” provided to a customer location such as a home or business. In larger commercial cable applications, a combination of indoor taps and splitters may be used to provide signals to multiple jacks from a single distribution line.

In current residential and commercial applications there is no adequate means for quickly identifying the location of serviceable customer equipment at a customer location, such as a home or business. Typically, a customer having a service issue (e.g., no data connection, poor quality television picture and so on) may describe the customer premises location as “the living room” or “the conference room” and so on. This description may be insufficiently accurate such that a support agent must ask a number of additional questions of the customer to determine which physical device is being referenced by the customer with respect to the service issue, such as inquiring as to the model number and/or serial number of the customer equipment or device in question. This takes time and effort on the part of both the support agent and the customer and may lead to a frustrating customer support experience.

Identifying the location of serviceable customer equipment in commercial environments such as hotels and the like may be even more difficult since there are many different locations, many different devices, multiple devices in closely related locations and so on.

The location of serviceable outlets may be mapped out during installation; such maps typically provide generic references to cable TV outlets, data port outlets, local area network (LAN) outlets and the like.

Unfortunately, these generic references, equipment maps and the like may become obsolete over time or may be misplaced. Further, the map only pertain to outlets rather than to the customer equipment connected to the outlets.

### BRIEF SUMMARY

Various deficiencies of the prior art are addressed by the present invention of systems, methods and apparatus implementing a service diagnostic mechanism wherein a “smart splitter” at a customer location for routing signal between an input or drop line and a plurality of outlets may be configured to associate each of the outlets with one or more useful identifier, such as a human friendly name indicating outlet location, model number or serial number of equipment associated with the outlet and so on.

One embodiment comprises apparatus implementing a smart splitter for use within, illustratively, a DOCSIS/MoCA enabled coaxial distribution system, wherein the splitter couples radiofrequency (RF) signal between an input connection and a plurality of output connections, wherein each output connection is associated with a respective outlet, the splitter including a management module, configured to receive identifying data associated with at least one outlet or customer device connected thereto.

### BRIEF DESCRIPTION OF THE DRAWINGS

The teachings of the present invention can be readily understood by considering the following detailed description in conjunction with the accompanying drawings, in which:

FIG. 1 depicts a block diagram of a system benefiting from various embodiments;

FIG. 2 depicts a flow diagram of a method according to one embodiment; and

FIG. 3 depicts a block diagram of a computing device suitable for use in performing various functions as described herein.

To facilitate understanding, identical reference numerals have been used, where possible, to designate identical elements that are common to the figures.

### DESCRIPTION

The invention will be primarily described within the context of a “smart splitter” at a customer location for routing signal between an input or drop line and a plurality of outlets may be configured to associate each of the outlets with one or more useful identifier, such as a human friendly name indicating outlet location, model number or serial number of equipment associated with the outlet and so on.

Further, compatible remote systems may communicate with the splitter to gather identification/Association information of outlets, equipment and the like to build a cable television distribution system map. This map may be used for remote management systems, billing or support systems, ease of device identification, location tracking and other service related functions.

The outlet identifying process may be facilitated via communication between the splitter and the various outlets using, illustratively, Multimedia over Coax (MoCA) or other communications means.

The remote communication process may be facilitated using in-band or out-of-band communication channels, such as via Data Over Cable Service Interface Specification (DOCSIS) or other communications means.

Those skilled in the art and informed by the teachings herein will realize that the invention is also applicable to various other embodiments as will be described herein.

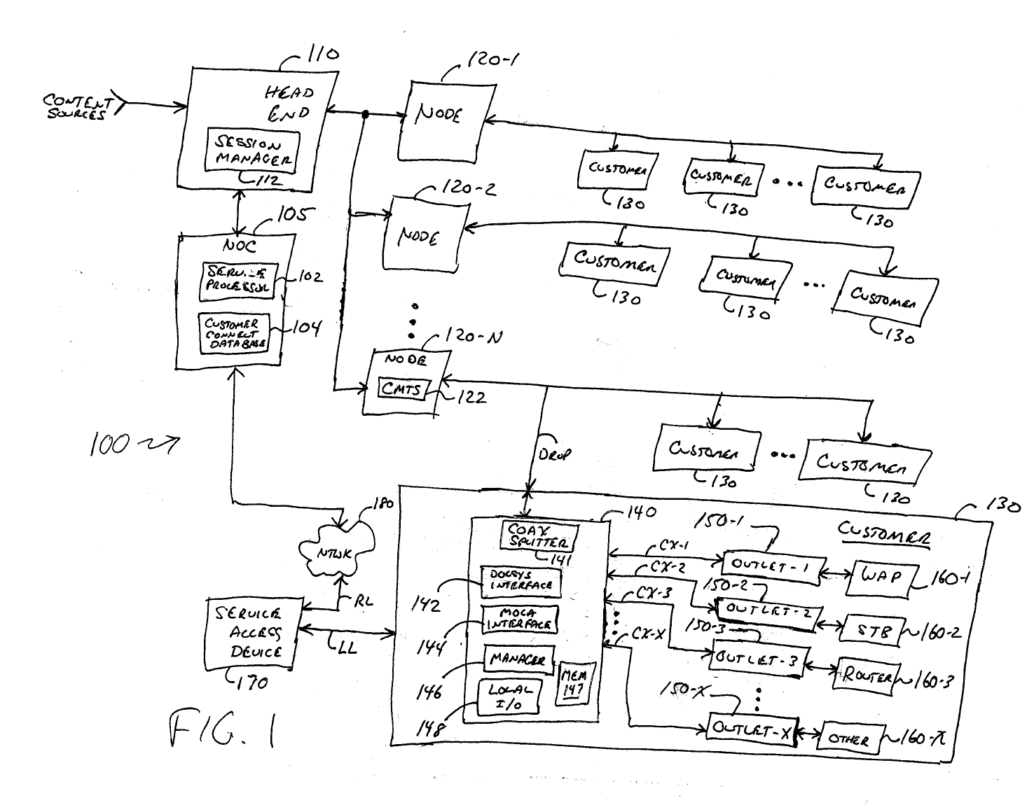

FIG. 1 depicts a block diagram of a system according to one embodiment. Specifically, FIG. 1 depicts a cable television distribution system 100 including customer equipment (CE) according to various embodiments.

Head end equipment 110 communicates in a known manner with each of a plurality of nodes 120 (e.g., neighborhood node), which in turn communicate in a known manner with CE 130 at each of a plurality of respective customer locations. A Network Operations Center (NOC) 105 or other network management entity communicates with the head end 110, nodes 120 and/or other elements within the network 100 to perform various management functions as is known.

The head end 110 includes a session manager 112 adapted to interact with CE 130 to perform various session management tasks, such as establishing streaming media sessions, authorizing/authenticating CE and television channels or other subscription packages, performing administrative functions and so on as is known. The head end 110 receives live or stored content from various content sources and provides such content to CE 130. Such content may include broadcast content, on-demand content and the like as is known.

The neighborhood nodes 120 may include a Cable Modem Termination System (CMTS) supporting interactive data communication between the head end 110 and CE equipment.

The customer equipment 130 may be arranged according to various configurations. The exemplary customer equipment 130 depicted in FIG. 1 comprises typical residential customer equipment comprising, illustratively, a smart splitter 140 in communication with a plurality of outlets 150-1 through 150-X (collectively outlets 150), where each outlet 150 may be associated with a respective customer device or appliance 160, such as a Wireless Access Point (WAP) 160-1, a set top box (STB) 160-2, a router 160-3 or some other device 160-X. Generally speaking, more or fewer outlets 150 may be used within the context of deployed customer equipment. Further, more or fewer customer devices 160 may be deployed. For example, within the context of a commercial environment, hundreds or even thousands of outlets 150 and/or customer devices 160 may be deployed. Further, multiple smart splitters 140 may also be deployed.

Various embodiments contemplate a smart splitter 140 including a single or dual RF coaxial input with a DOCSIS interface to enable remote management, and including an internal RF bridge coupling signal between the RF coaxial input and multiple RF coaxial outputs to provide a splitting function thereby. Optionally, one or more of the bridged RF signals are amplified.

As depicted in FIG. 1, the exemplary smart splitter 140 is coupled to a signal input or drop line CX-D to enable communication between the smart splitter 140 and a corresponding node 120. The smart splitter 140 includes, illustratively, a coaxial splitter 141 operative to split input radiofrequency (RF) signal received from node 120 into a plurality of RF sub-signals which are propagated to respective outlets 150-1 through 150-X via respective lines coaxial lines CX-1 through CX-X. Generally speaking, each of the coaxial lines CX supports bidirectional signals for propagating data and/or content between the splitter 140 and a respective customer device or appliance 160.

The smart splitter 140 is also depicted as including a DOCSIS interface 142, a MoCA interface 144, a manager module 146, a memory 147 and a local input/output (I/O) module 148. As discussed in more detail below, various embodiments utilize some or all of these elements. It will be appreciated that the configuration of the smart splitter 140 is simplified for this discussion; various computing elements such as processors, memory, input/output modules and the like, field programmable gate arrays (FPGA) and/or other known mechanisms may be used to implement the various components and subcomponents thereof described herein with respect to the smart splitter 140.

The MoCA interface 144 supports communications between the smart splitter 140 and the various outlets 150. That is, the MoCA interface 144 provides an outlet-facing interface whereby the smart splitter 140 may gather information from the outlets 150 and/or customer devices 160 suitable for use in associating an identifier with the various outlets 150 and/or customer devices 160. For example, each outlet 150 may be associated with a location-indicative name, such as a room name, room number, grid coordinates, floor/room number, outlet number/identifier and so on. Similarly, each customer device 160 connected to an outlet may be queried to retrieve a manufacturer number, a model number, a serial number, a revision number and/or other information. Thus, in various embodiments, outlets 150 and/or customer devices 160 include appropriate hardware to facilitate such communication with the smart interface 144.

The DOCSIS interface 142 supports communications between the smart splitter 140 and the node 120 as well as the head end 110. The DOCSIS interface 142 may be implemented within the context of a cable modem as is known.

The manager module 146 provides various management functions associated with the smart splitter 140 and customer equipment in general, such as using the MoCA interface 144 to gather information from outlets 150 and/or customer devices 160, using the DOCSIS interface 142 to propagate gather information toward the node 120, head end 110 and/or NOC 105.

The local I/O interface 148 may be used to provide communications between the smart splitter 140 and a service access device 170, such as a laptop computer, craft interface terminal or other diagnostic device utilized by service personnel at the customer location.

The service access device 170 may communicate with the smart splitter 140 using a local link (LL) connection such as via any of a telephone jack supporting a Plain Old Telephone Service (POTS), Voice over Internet Protocol (VoIP) or other telephone connection, network jack supporting a wireline network connection, or a wireless connection (e.g., via WAP 160-1).

The service access device 170 may communicate with the smart splitter 140 using a remote link (RL) connection through a network 180 such as a cellular telephone network or other network. It will be noted that while the network 180 is depicted as communicating directly with the NOC 105, various embodiments contemplate the network 180 as communicating the smart splitter 140 via other system elements such as the head end 110, node 120, other customers 130 and the like.

In various embodiments, service personnel utilize the service access device 170 or other device to identify and name various attributes associated with of outlets 150 and/or customer devices 160. Specifically, in various embodiments the service access device 170 functions as a system management console providing service personnel with an ability to name the customer device 160 and/or the outlet 150 to which the customer device 160 is connected. That is, while at a customer site (such as during initial equipment setup or subsequent equipment troubleshooting), service personnel installing or troubleshooting customer devices 160 connected to outlets 150 use the service access device 170 to determine which customer device 160 is coupled to which outlet 150, logically pair the connected devices and outlets to form logical device/outlet pairs, provide a name, location or other identifier associated with device/outlet pairs or individual devices/outlets (“STB with DVR in living room”, “WAP in downstairs office” and the like), associate information with device/outlet pairs or individual devices/outlets (e.g., manufacturer, model number, serial number, Media Access Control (MAC) address, device capability indicator and the like), and perform other functions.

The memory 147 includes a tangible and non-transitory memory for storing information such as outlet identification or other information, device identification or other information outlet to device connection information and so on. The memory 147 may comprise a standalone memory as depicted, or may be included within the manager module 146, DOCSIS interface 142, a MoCA interface 144 and/or local I/O interface 148.

In various embodiments manager module 146 operates to associate each outlet connected to a device with the respective device connected thereto, wherein information indicative of this connection may be stored in the memory 147. Further, other optional information pertaining to outlets, devices, and/or outlet/device pairs may also be stored in the memory. In various embodiments, this information is retrieved from memory by a local or remote service device.

In various embodiments, rather than the manager module 146, a local or remote service device can be used to gather this information during, for example, initial installation or subsequent service at customer premises, which information may then be stored at the customer premises in the memory 147 or other memory within the splitter 140 or other portion of the system. For example, some or all of the contents of the memory may be distributed among each of a plurality of devices connected to the splitter 140.

In various embodiments, name, configuration, function or other data associated with identified device/outlet pairs or individual devices/outlets is passed to compatible MoCA enabled devices within the customer premises using, illustratively, link discovery protocol (LDP) over MoCA, such as described in US patent application publication 20130176900 A1, which is incorporated herein by reference in its entirety. For example, one or more of the customer devices 160 may comprise MoCA enabled devices capable of communicating with each other and storing data pertaining to other outlets 150 and/or customer devices 160.

In various embodiments, information obtained by a connected device via an intra-premises distribution system such as MoCA may be stored in a Simple Network Management Protocol (SNMP) sysLocation field or similar structure.

In various embodiments, the LLDP over MoCA mechanism is used to enable customer devices 160 to communicate with each other such that data pertaining to various device/outlet pairs or individual devices/outlets may be provided to each customer device. Such data may include, illustratively, manufacturer, model, serial number, media access control (MAC), human-friendly name assigned to device by service personnel and/or other information.

Thus, various connected devices are able to learn about each other and, further, mapping information pertaining to device/outlet pairs as well as individual devices/outlets may be augmented by the various other customer devices 160.

Further, the information pertaining to the device/outlet pairs as well as individual devices/outlets may be propagated back toward the NOC 105 or other network entity such that a detailed map of the entire cable system may be determined by, illustratively, the service processor 102 and stored in the customer connect database 104. By tracking service issues, performance issues and so on a substantially real time view of system performance as a whole, individual components as a whole throughout the system and other pertinent management data may be determined.

The above-described information enables managed information distribution system to use queries via accepted standards (e.g., SNMP) to enable back-office systems to learn, for each customer location, the connection topology associated with that location, the topology including the outlets 150 and devices 160 connected thereto. Thus, when sending a service technician to a customer location for the purpose of addressing a service issue, the outlet/device pair information or individual outlet/device information enables the service technician to immediately begin working on the particular outlet or device associated with the service issue without wasting time trying to determine which outlet or device is associated with the service issue.

The NOC 105 may include a service processor 102 for performing various remote diagnostic functions, customer equipment identification functions, service personnel interaction functions and the like, as well as a customer connection database 104 for storing mapping information associated with outlets and/or equipment at customer locations.

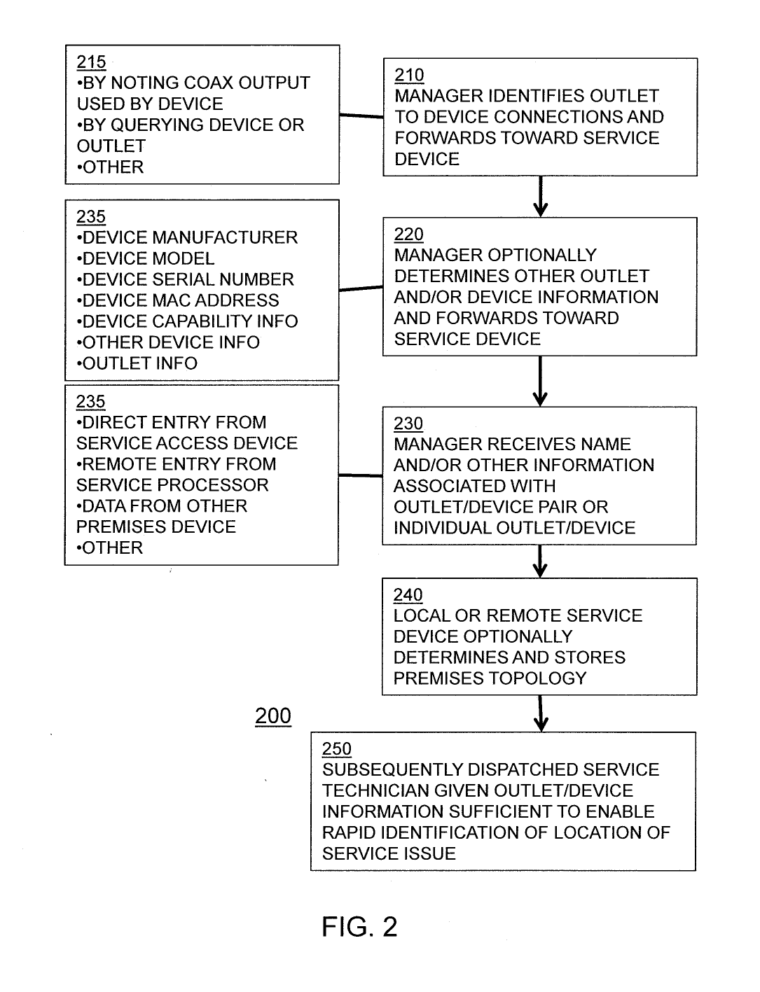

FIG. 2 depicts a flow diagram of a method according to one embodiment. Specifically, FIG. 2 depicts a flow diagram of a method 200 suitable for implementing the various functions as described above with respect to the smart splitter 140.

At step 210, a manager or other entity such as manager 146 associated with the smart splitter identifies outlet to device connections and forwards this information toward a service device, such as the service access device 170. Referring to box 215, this identification is made by noting the coaxial splitter output line used by the device, by querying the device or outlet, or by some other means.

At step 220, the manager optionally determines other outlet and/or device information and forwards this information toward the service device. Referring to box 235, this information may comprise device manufacturer, device model, device serial number, device MAC address, device capability information, other device information and/or outlet information.

At step 230, the manager receives name and/or other information associated with the outlet/device pair or an individual outlet or device. Referring to box 235, this information may be provided to the manager via direct entry from a service access device, via remote entry from a service provider (e.g., service processor 102), via data provided from other premises devices (e.g., the customer devices 160), or by some other means. For example, service personnel may directly enter human interpretable/readable descriptive information pertaining to the outlet, device and/or outlet/device pair as previously discussed. Such entry may be made through the service access device 170 or service processor 102. Alternatively, an automatic naming or identification nomenclature may be used to identify each outlet, device or outlet/device pair. For example, service processor 102 may operate to generate appropriate names or identifiers in response to information received from the manager, which identifiers are then stored by the manager for use in identifying outlets, devices or outlet/device pairs is desired.

At step 240, local or remote server devices may optionally determine and store premises topology information. That is, at step 240 the service access device 170 and/or service processor 102 may determine the outlet/device topology associated with the particular premises and, further, integrate this topology information into a broader topology of a local, regional, or entire network. This information may be used for management purposes, and network optimization/performance purposes and so on. That is, in various embodiments, for each customer premises a corresponding premises topology map may be generated using identifying data associated with each of a plurality of outlet/device pairs at the customer premises. Further, for each neighborhood a corresponding neighborhood topology map may be generated using the respective premises topology maps of each of the customer premises in the neighborhood. Finally, for the system as a whole, a system topology map may be generated using respective neighborhood topology maps of each of the neighborhoods in the system.

At step 250, subsequently dispatched service technicians are given outlet/device information sufficient to enable rapid identification of a particular location associated with a service issue. That is, given a particular customer location having service issue associated with a particular outlet and/or customer device, the dispatched service technician is given identifying information associated with the particular outlet and/or customer device so that the technician may immediately begin working on the correct outlet and/or customer device. In this manner, the technician avoids wasting time by searching for particular outlets and/or customer devices which may or may not be the cause of the service issue.

Various modifications to the method 200 will be appreciated by those skilled in the art. Further, different entities other than those described herein may also be used to perform the various functions.

In various embodiments, the functions described above with respect to the manager (e.g., manager 146), may be performed in whole or in part by the service access device 170 or some other entity retrieving outlet and device connection information directly, via the manager 146 and/or via the MoCA interface 144. For example, in various embodiments the service access device 170 is utilized by a service technician to identify outlet to device connections such as described with respect to step 210. In various embodiments, the service access device 170 optionally determines other outlet and/or device information such as described with respect to step 220. In various embodiments, the service access device 170 stores name and/or other information associated with outlet/device pairs or individual outlets/devices and memory located on the premises, such as at the smart splitter 140.

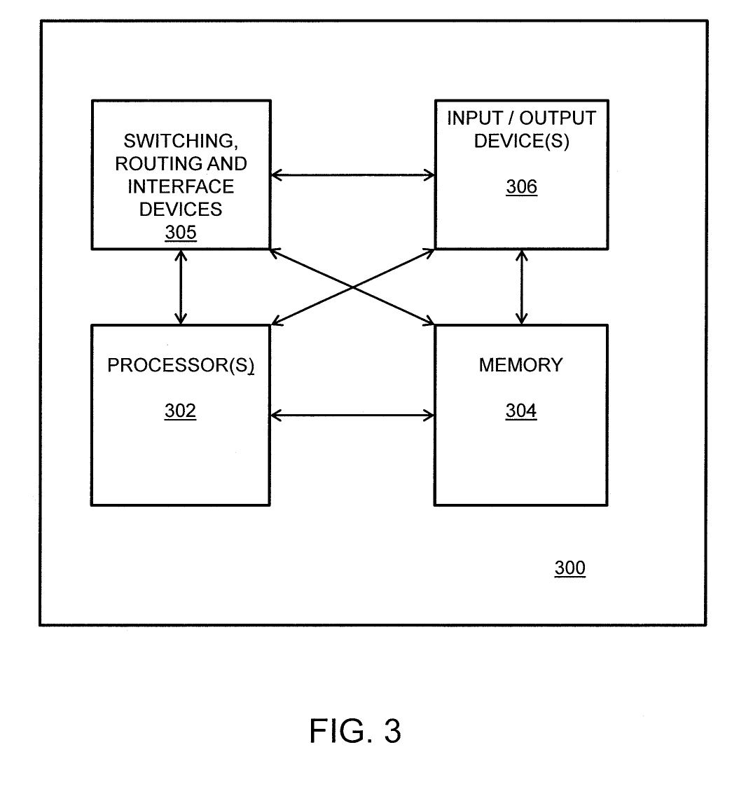

FIG. 3 depicts a high-level block diagram of a computing device suitable for use in performing functions described herein such as those associated with the various elements described herein with respect to the figures. For example, the computing device 300 is suitable for use in implementing at least some portions of the NOC 105, head end 110, nodes 120, customer equipment 130 and service access device 170. Further, the computing device 300 is suitable for use in implementing at least some portions of the smart splitter 140 and customer devices 160 described herein with respect to the customer equipment 130.

As depicted in FIG. 3, computing device 300 includes a processor element 302 (e.g., a central processing unit (CPU) and/or other suitable processor(s)), a memory 304 (e.g., random access memory (RAM), read only memory (ROM), and the like), cooperating module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

In the case of a routing or switching device or component thereof such as head end 110, node 120, customer equipment 130 and the like, the cooperating module or process 305 may implement various switching devices, routing devices, interface devices and so on as known to those skilled in the art. Thus, the computing device 300 is implemented within the context of such a routing or switching device (or within the context of one or more modules or sub-elements of such a device), further functions appropriate to that routing or switching device are also contemplated and these further functions are in communication with or otherwise associated with the processor 302, input/output devices 306 and memory 304 of the computing device 300 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various embodiments contemplate an apparatus including a processor and memory, where the processor is configured to generate identifying data associated with at least one outlet or customer device connected thereto; and forward the identifying data toward a radiofrequency (RF) signal splitter including at least one splitter output connection in communication with a corresponding outlet or customer device connected thereto, said identifying data configured to be stored in a tangible and non-transitory memory at the signal splitter.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. Apparatus, comprising:
a splitter, for coupling radiofrequency (RF) signal between an input connection and a plurality of output connections, wherein each output connection is associated with a respective outlet; and
a management module, configured to receive identifying data associated with at least one outlet or customer device connected thereto.

2. The apparatus of claim 1, wherein said management module is further configured to store said identifying data in a tangible and non-transitory memory.

3. The apparatus of claim 1, wherein said management module is further configured to interact with a service access device to receive said identifying data.

4. The apparatus of claim 1, wherein said identifying data is associated with at least one logical pair comprising an outlet and a customer device connected thereto.

5. The apparatus of claim 1, wherein said identifying data comprises one or more of a name, a premises location and an identifier associated with an outlet.

6. The apparatus of claim 1, wherein said identifying data comprises one or more of a manufacturer name, a model number, a serial number, a Media Access Control (MAC) address and a device capability indicator associated with a customer device connected to an outlet.

7. The apparatus of claim 4, wherein said identifying data comprises for each outlet/device logical pair, a respective one or more of a name, a premises location and an identifier associated with an outlet, and a respective one or more of a manufacturer name, a model number, a serial number, a Media Access Control (MAC) address and a device capability indicator associated with a customer device connected to the outlet.

8. The apparatus of claim 3, wherein said service access device comprises a portable diagnostic device configured to support service personnel at a customer location.

9. The apparatus of claim 8, wherein said service access device communicates with said management module via a local link supported by any of a local telephone connection, local network connection and local wireless access point (WAP).

10. The apparatus of claim 8, wherein said service access device communicates with said management module via a remote link supported by wireless communication network.

11. A method, comprising:
at a service access device, generating identifying data associated with at least one outlet or customer device connected thereto; and
at said service access device, forwarding said identifying data toward a radiofrequency (RF) signal splitter including at least one splitter output connection in communication with a corresponding outlet or customer device connected thereto, said identifying data configured to be stored in a tangible and non-transitory memory at the signal splitter.

12. The method of claim 11, wherein said identifying data is associated with at least one logical pair comprising an outlet and a customer device connected thereto.

13. The method of claim 11, wherein said identifying data comprises one or more of a name, a premises location and an identifier associated with an outlet.

14. The method of claim 11, wherein said identifying data comprises one or more of a manufacturer name, a model number, a serial number, a Media Access Control (MAC) address and a device capability indicator associated with a customer device connected to an outlet.

15. The method of claim 12, wherein said identifying data comprises for each outlet/device logical pair, a respective one or more of a name, a premises location and an identifier associated with an outlet, and a respective one or more of a manufacturer name, a model number, a serial number, a Media Access Control (MAC) address and a device capability indicator associated with a customer device connected to the outlet.

16. The method of claim 12, further comprising generating a premises topology map using identifying data associated with each of a plurality of identified outlet/device pairs at a customer premises.

17. The method of claim 16, further comprising generating a neighborhood topology map using respective premises topology maps of each of the customer premises in a neighborhood.

18. The method of claim 17, further comprising generating a system topology map using respective neighborhood topology maps of each of the neighborhoods in a system.

19. An apparatus including a processor and memory, where the processor is configured to:
generate identifying data associated with at least one outlet or customer device connected thereto; and
forward said identifying data toward a radiofrequency (RF) signal splitter including at least one splitter output connection in communication with a corresponding outlet or customer device connected thereto, said identifying data configured to be stored in a tangible and non-transitory memory at the signal splitter.

20. The apparatus of claim 19, wherein said apparatus comprises a portable diagnostic device configured to support service personnel at a customer location and to communicate with said signal splitter via one of a local link supported by any of a local telephone connection, local network connection and local wireless access point (WAP), and a remote link supported by wireless communication network.
